(19) United States
(12) Patent Application Publication
(10) Pub. No.: US 2026/0260447 A1
(43) Pub. Date: Sep. 3, 2026

(54) TARGET DETECTION METHOD AND APPARATUS, DEVICE, AND STORAGE MEDIUM

(71) Applicants: BEIJING ACADEMY OF SCIENCE AND TECHNOLOGY, Beijing (CN); Institute of Urban Safety and Environmental Science, Beijing Academy of Science and Technology, Beijing (CN)

(72) Inventors: Yueying KAO, Beijing (CN); Wenjie Yang, Fuzhou (CN); Tong Liu, Beijing (CN); Yan Liu, Beijing (CN); Yan Qin, Beijing (CN); Chunli Yang, Beijing (CN)

(21) Appl. No.: 19/241,642

(22) Filed: Jun. 18, 2025

(30) Foreign Application Priority Data
Feb. 28, 2025 (CN) 202510238568.5

(51) Int. Cl. G06V 10/25; G06V 10/26; G06V 10/42; G06V 10/762; G06V 10/764; G06V 10/77; G06V 10/82; G06V 20/40

(52) U.S. Cl. CPC G06V 10/25; G06V 10/26; G06V 10/42; G06V 10/762; G06V 10/764; G06V 10/7715; G06V 10/82; G06V 20/46; G06V 2201/07

(57) ABSTRACT

The present application relates to a target detection method and apparatus, a device, and a storage medium. A main technical solution includes: acquiring video set data, inputting the video set data to a backbone network to obtain video frame feature data, inputting the video frame feature data to a convolutional neural network to obtain candidate box data of a target object, optimizing the candidate box data of the target object according to a preset uncertainty estimation loss model to obtain candidate box feature data, and inputting the candidate box feature data to a preset cross-frame and cross-view model for updating and then outputting to obtain a target box and corresponding target detection data.

### CROSS-REFERENCE TO RELATED APPLICATION

This application claims priority to China Patent Application 202510238568.5, filed on Feb. 28, 2025, which is incorporated herein by reference.

### FIELD

The present application relates to the technical field of detection and recognition, in particular to a target detection method and apparatus, a device, and a storage medium.

### BACKGROUND

It is well known that a confined space refers to a completely or partially closed region, and working personnel may carry out construction, maintenance, repair, cleaning and other activities in a confined space. However, the confined space is narrow in entrance and poor in ventilation and is easily accumulated with harmful substances therein, and therefore, it brings a major risk to the physical and mental health of the working personnel. It is indicated by statistical data that a large number of workers are injured or killed every year when working in confined spaces, and therefore, further assessment for the safety of operation in the confined space is crucial to guarantee the safety and health of workers. Herein, the assessment for the safety of operation in the confined space aims at assessing whether there are safety protection devices on site and whether operating personnel working in wells need to be provided with safety protection apparatuses. In some embodiments, the task for assessing the safety of operation in the confined space mainly relates to two basic processes, i.e., target object detection and attribute recognition, but a key to the two tasks both faces the following challenges: (1) target occlusion: due to the confined space, most of targets including the operating personnel are seriously occluded in a working scenario; (2) nonrigid deformation of an object: when targets such as an air blower, a safety belt and an air respirator are operated by the working personnel, nonrigid deformation is easy to occur; and (3) small objects: a large number of safety devices such as a gas detector and an automatic control instrument for a speed difference are included in an operating scenario of the confined space.

In the related art, the target operating in the confined space is further detected and assessed by adopting a machine learning method in most cases. However, there is no design or optimization for difficulties such as occlusion in the operating scenario in the confined space in most of methods, and thus, the target detection performance is significantly lowered. Of course, there are also individual methods in which occluded target detection is researched. For example, there is a part-level occlusion labeling way to enhance the detection for the occluded object and a part-based voting method to detect a semantic part of the occluded object.

However, in the above-mentioned ways, a fixed box size is adopted, and a candidate box is not further optimized and updated, which makes the finally obtained target detection object not very accurate, and thus, the operating safety of the operating personnel in the confined space may not be further guaranteed.

### SUMMARY

In view of this, the present application provides a target detection method and apparatus, a device, and a storage medium. Candidate box data of a target object may be optimized and updated based on an uncertainty estimation loss model and a cross-frame and cross-view model to obtain a more accurate target box and corresponding target detection data, and thus, the effects of effectively reducing the computation cost, reducing information redundancy and increasing the detection precision and efficiency are achieved.

In a first aspect, provided is a target detection method, and the method includes:
acquiring video set data; the video set data referring to data formed by paired video sets taken from different views in a certain region;
inputting the video set data to a backbone network to obtain video frame feature data;
inputting the video frame feature data to a convolutional neural network to obtain candidate box data of a target object;
optimizing the candidate box data of the target object according to a preset uncertainty estimation loss model to obtain candidate box feature data; and
inputting the candidate box feature data to a preset cross-frame and cross-view model for updating and then outputting to obtain a target box and corresponding target detection data.

According to an implementable way in some embodiments of the present application, the optimizing the candidate box data of the target object according to a preset uncertainty estimation loss model to obtain candidate box feature data includes:
pooling the candidate box data of the target object to obtain local feature data of candidate boxes;
performing occlusion classification on the local feature data of the candidate boxes according to a preset probability model to obtain local feature occlusion probability data of the candidate boxes; and
optimizing the candidate box data of the target object according to the local feature occlusion probability data of the candidate boxes and the preset uncertainty estimation loss model to obtain the candidate box feature data.

According to an implementable way in some embodiments of the present application, the optimizing the candidate box data of the target object according to the local feature occlusion probability data of the candidate boxes and the preset uncertainty estimation loss model to obtain the candidate box feature data includes:
acquiring ground truth box data of the target object, and performing intersection over union on the candidate box data of the target object and the ground truth box data of the target object to obtain foreground box data and background box data;
obtaining certain box data and uncertain box data according to the local feature occlusion probability data of the candidate boxes, the foreground box data and the background box data; and
inputting the certain box data and the uncertain box data to the preset uncertainty estimation loss model for optimization to obtain the candidate box feature data.

According to an implementable way in some embodiments of the present application, the inputting the certain box data and the uncertain box data to the preset uncertainty estimation loss model for optimization to obtain the candidate box feature data includes:
performing training supervision on the certain box data according to a first preset confidence score model to obtain certain box supervision data;
performing training supervision on the uncertain box data according to a second preset confidence score model and a preset regularized loss model to obtain uncertain box supervision data; and
inputting the certain box supervision data and the uncertain box supervision data to the preset uncertainty estimation loss model for optimization to obtain the candidate box feature data.

According to an implementable way in some embodiments of the present application, the inputting the candidate box feature data to a preset cross-frame and cross-view model for updating and then outputting to obtain a target box and corresponding target detection data includes:
Performing global pooling processing on the candidate box feature data to obtain global feature data of the candidate boxes;
inputting the global feature data of the candidate boxes to the preset cross-frame and cross-view model for cross-frame and cross-view processing to obtain candidate box update data; and
hierarchically outputting the candidate box update data to obtain the target box and the corresponding target detection data.

According to an implementable way in some embodiments of the present application, the preset cross-frame and cross-view model includes a preset cross-frame model and a preset cross-view model, and the inputting the global feature data of the candidate boxes to the preset cross-frame and cross-view model for cross-frame and cross-view processing to obtain candidate box update data includes:
inputting the global feature data of the candidate boxes to the preset cross-frame model, and performing clustering cross-frame processing on the global feature data of the candidate boxes to obtain clustering cross-frame data of the candidate boxes; and
inputting the clustering cross-frame data of the candidate boxes to the preset cross-view model, and performing cross-view updating on the clustering cross-frame data of the candidate boxes to obtain the candidate box update data.

According to an implementable way in some embodiments of the present application, the hierarchically outputting the candidate box update data to obtain the target box and the corresponding target detection data includes:
inputting the candidate box update data to a first fully-connected layer to obtain target object category prediction probability data of the candidate boxes;
inputting the candidate box update data to a second fully-connected layer to obtain various category box prediction offset data of the candidate boxes; and
obtaining the target box and the corresponding target detection data according to the target object category prediction probability data of the candidate boxes and the various category box prediction offset data of the candidate boxes.

In a second aspect, provided is a target detection apparatus, and the apparatus includes:
an acquisition unit configured to acquire video set data; the video set data referring to data formed by paired video sets taken from different views in a certain region;
a first input unit configured to input the video set data to a backbone network to obtain a video frame feature data;
a second input unit configured to input the video frame feature data to a convolutional neural network to obtain candidate box data of a target object;
an optimization unit configured to optimize the candidate box data of the target object according to a preset uncertainty estimation loss model to obtain candidate box feature data; and
an update detection unit configured to input the candidate box feature data to a preset cross-frame and cross-view model for updating and then outputting to obtain a target box and corresponding target detection data.

In a third aspect, provided is a computer device, including:
at least one processor; and
a memory in communication connection with the at least one processor; where
the memory stores computer instructions executable for the at least one processor, and the computer instructions are executed by the at least one processor so that the at least one processor is capable of performing the method involved in the above-mentioned first aspect.

In a fourth aspect, provided is a non-transitory computer-readable storage medium having computer instructions stored thereon, where the computer instructions are configured to enable a computer to perform the method involved in the above-mentioned first aspect.

According to the technical contents provided in the embodiments of the present application, video set data is acquired, the video set data referring to data formed by paired video sets taken from different views in a certain region; the video set data is inputted to a backbone network to obtain video frame feature data; the video frame feature data is inputted to a convolutional neural network to obtain candidate box data of a target object; the candidate box data of the target object is optimized according to a preset uncertainty estimation loss model to obtain candidate box feature data; and the candidate box feature data is inputted to a preset cross-frame and cross-view model for updating and then outputting to obtain a target box and corresponding target detection data. Based on the above-mentioned operation, the candidate box data of the target object may be optimized and updated based on the uncertainty estimation loss model and the cross-frame and cross-view model to obtain a more accurate target box and corresponding target detection data, and thus, the effects of effectively reducing the computation cost, reducing information redundancy and increasing the detection precision and efficiency are achieved.

### BRIEF DESCRIPTION OF THE DRAWINGS

FIG. 1 is an application environment diagram of a target detection method in some embodiments;

FIG. 2 is a schematic process diagram of the target detection method in some embodiments;

FIG. 3 is a structural block diagram of the target detection method in some embodiments;

FIG. 4 is a schematic diagram of performing occlusion classification on local feature data of candidate boxes according to a preset probability model in the target detection method in some embodiments;

FIG. 5 is a schematic diagram of performing intersection over union on candidate box data of a target object and ground truth box data of the target object in the target detection method in some embodiments;

FIG. 6 is a schematic diagram of inputting global feature data of candidate boxes to a preset cross-frame and cross-view model for cross-frame clustering and cross-view clustering in the target detection method in some embodiments;

FIG. 7 is schematic process diagram of the target detection method in some embodiments;

FIG. 8 is a structural block diagram of a target detection apparatus in some embodiments; and

FIG. 9 is a schematic structural diagram of a computer device in some embodiments.

### DETAILED DESCRIPTION

In order to make objects, technical solutions and advantages of the present application clearer and more understandable, the present application will be further described in detail below in conjunction with the accompanying drawings and embodiments. It should be understood that the embodiments described herein are only intended to explain the present application, rather than to limit the present application.

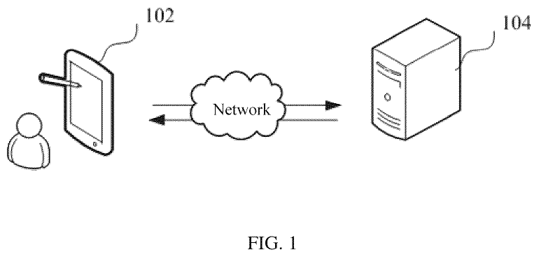

The present application provides a target detection method which may be applied to an application environment shown in FIG. 1. A terminal 102 communicates with a server 104 via a network. In some embodiments, the server 104 acquires video set data collected by the terminal 102. The video set data refers to data formed by paired video sets taken from different views in a certain region. The video set data is inputted to a backbone network to obtain video frame feature data. The video frame feature data is inputted to a convolutional neural network to obtain candidate box data of a target object. The candidate box data of the target object is optimized according to a preset uncertainty estimation loss model to obtain candidate box feature data. And the candidate box feature data is inputted to a preset cross-frame and cross-view model for updating and then outputting to obtain a target box and corresponding target detection data. The terminal 102 may be, but is not limited to various personal computers, notebook computers, smart phones, and tablet computers, and the server 104 may be implemented by an independent server or a server cluster composed of a plurality of servers.

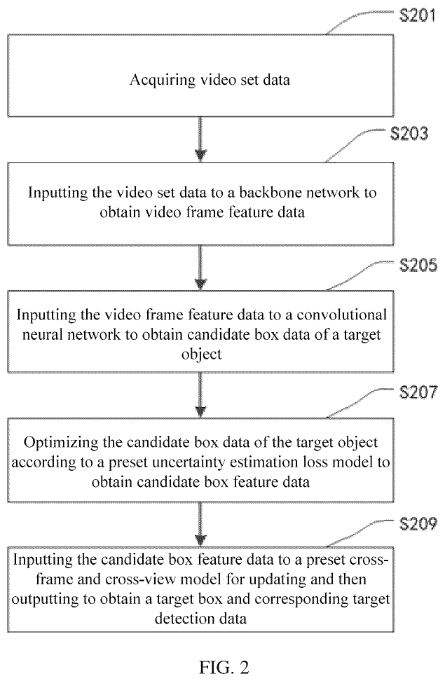

FIG. 2 is a process diagram of a target detection method provided in some embodiments of the present application, and the method may be performed by the server 104 in the application environment shown in FIG. 1. As shown in FIG. 2, the method may include the following steps:
step S201: video set data is acquired.

The video set data refers to data formed by paired video sets taken from different views in a certain region. In the present application, data formed by paired video sets taken from two different views in a certain region may be used as the video set data, and the certain region includes, but is not limited to an operating region with a confined space.

Herein, with the operating region of the confined space as an example, the confined space refers to a completely or partially closed region. When working personnel carry out artificial construction, maintenance, repair, cleaning and other activities in the confined space, the physical and mental health may be affected to a certain extent due to problems such as narrow entrance, poor ventilation and easily accumulated harmful substances, and therefore, unsafe behaviors before operation in the confined space may be detected and recognized, and thus, early warning for prompt and effective management are performed according to a recognition result. In some embodiments, videos from two views may be taken in real time on the site of the operating region of the confined space to detect important target objects or tools, thereby guaranteeing the operating safety of the working personnel and predicting the basic attributes of workers in wells. The basic attributes include whether the workers wear safety helmets, safety belts, gas detectors, respirators, etc.

One way to collect data from two different views is to use two cameras facing each other to simultaneously capture the certain region, which may capture almost all the views of the certain region and collect two videos. Then frame extraction is performed on a collected video, for example, for a 30 fps frame rate video, 1 or 2 frames are extracted in 1 second, etc., for later algorithm processing. The frame extraction will be comprehensively considered based on a processing speed and accuracy of the algorithm to achieve real-time video processing.

Step S203: the video set data is inputted to a backbone network to obtain video frame feature data.

The backbone network includes, but is not limited to a VGG (Visual Geometry Group, Deep Convolutional Neural Network Architecture), a Resnet (Residual Neural Network) 50 network, and a Resnet18 network.

Herein, the video set data is inputted to the backbone network, the backbone network is composed of a deep convolutional neural network, and therefore, the corresponding video frame feature data may be directly obtained.

Step S205: the video frame feature data is inputted to a convolutional neural network to obtain candidate box data of a target object.

The convolutional neural network includes, but is not limited to an RPN (Region Proposal Network) network.

Herein, the video frame feature data is inputted to the RPN network to obtain the candidate box data of the target object, and it is not to be repeated excessively, and a loss function corresponding thereto is further described in detail. In some embodiments, an expression of the loss function thereof may be expressed as follows:

$${L}_{rpn} = \frac{1}{{N}_{cls}} {\sum }_{i = 1}^{{N}_{cls}} {L}_{cls} ( {p}_{i} , {p}_{i}^{*} ) + λ \frac{1}{{N}_{reg}} {\sum }_{i = 1}^{{N}_{cls}} {p}_{i}^{*} {L}_{reg} ( {t}_{i} , {t}_{i}^{*} )$$

where L_{cls} is a binary classification, that is, whether it is a log loss function of the target object. L_{reg} is a regression loss function which may also be equivalent to a smooth L1 loss function, that is,

$${L}_{reg} ( {t}_{i} , {t}_{i}^{*} ) = {smooth}_{L 1} ( {t}_{i} , {t}_{i}^{*} ) .$$

i represents the i^{th} anchor point of a candidate box. pᵢ represents a predicted probability that the i^{th} anchor point becomes the target object. p*ᵢ represents a real probability that the i^{th} anchor point is the target object and may be preset in advance. tᵢ represents a predicted coordinate value of the candidate box and may be represented by (t_{z}, t_{y}, t_{w}, tₕ).

$${t}_{i}^{*}$$

represents a real coordinate value of the candidate box and may be preset in advance. N_{cls} represents a category constant and may be set as 2 in the present application. N_{reg} represents the number of candidate boxes and is a constant. λ represents a preset weight parameter and is also a constant. And model training is performed based on the above-mentioned loss functions, and thus, the candidate box data of the target object may be obtained.

Step S207: the candidate box data of the target object is optimized according to a preset uncertainty estimation loss model to obtain candidate box feature data.

Herein, after the candidate box data of the target object is obtained, candidate boxes in the candidate box data of the target object are pooled into the candidate box data with the same size by an Rol (Region of Interest Pooling Layer), and the candidate box data is optimized based on the preset uncertainty estimation loss model to obtain the candidate box feature data. That is, an uncertainty estimation model sensing occlusion senses whether various parts of candidate boxes in the candidate box data of the target object are occluded, that is, hierarchical occlusion labeling of the candidate boxes may be utilized to predict part-level visibility, and uncertainty modeling is performed by occlusion labeling, so that the occlusion challenge prevalent in the current scenario is solved. In some embodiments, candidate boxes in the candidate box data of the target object are divided into several parts which are respectively subjected to occlusion labeling, and further optimization is achieved by means of the preset uncertainty estimation loss model, and thus, the candidate box feature data is obtained.

Step S209: the candidate box feature data is inputted to a preset cross-frame and cross-view model for updating and then outputting to obtain a target box and corresponding target detection data.

Herein, example-level information in videos is considered in the above-mentioned uncertainty estimation way sensing occlusion during occlusion processing. In a general case, we will involve a plurality of videos from different views, and therefore, a plurality of video data from different views may be processed based on the cross-frame and cross-view model. Moreover, thousands of candidate boxes are generated by each frame of the RPN, and if these candidate boxes of a plurality of video frames are used for detection and recognition, the computation cost will be significantly increased, and therefore, before being inputted to the preset cross-frame and cross-view model, the candidate box feature data may also be clustered to facilitate adding candidate boxes in context into a predefined number of classifications in group, these classifications may serve as key reference for current frame prediction, and thus, the effects of effectively reducing the computation cost and reducing information redundancy are achieved. After being clustered, the candidate box feature data is inputted to a preset cluster updating module for updating, and two-layer output is performed after the updating is completed, so that the target box and the corresponding target detection data are obtained.

It may be seen that in the embodiments of the present application, video set data is acquired, the video set data referring to data formed by paired video sets taken from different views in a certain region. The video set data is inputted to a backbone network to obtain video frame feature data. The video frame feature data is inputted to a convolutional neural network to obtain candidate box data of a target object. The candidate box data of the target object is optimized according to a preset uncertainty estimation loss model to obtain candidate box feature data. And the candidate box feature data is inputted to a preset cross-frame and cross-view model for updating and then outputting to obtain a target box and corresponding target detection data. Based on the above-mentioned operation, the candidate box data of the target object may be optimized and updated based on the uncertainty estimation loss model and the cross-frame and cross-view model to obtain a more accurate target box and corresponding target detection data, and thus, the effects of effectively reducing the computation cost, reducing information redundancy and increasing the detection precision and efficiency are achieved.

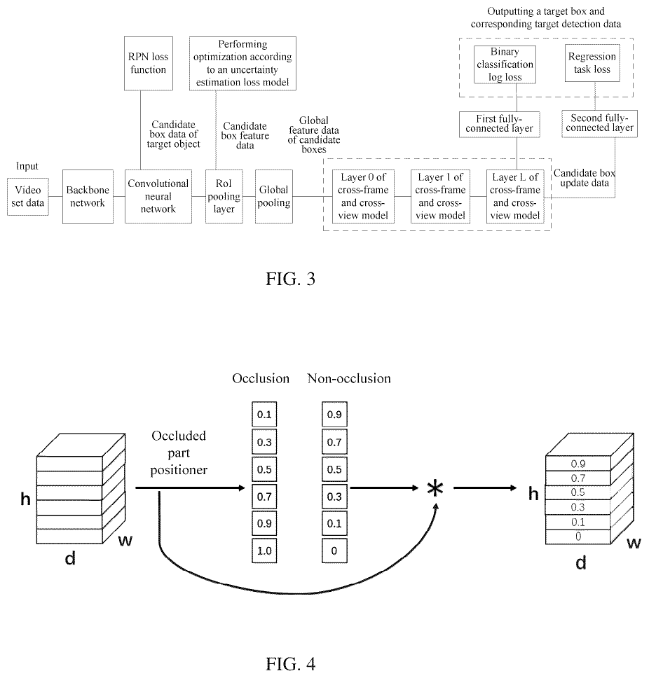

Important steps in the above-mentioned method processes will be described in detail below. Firstly, the above-mentioned step 207 that “the candidate box data of the target object is optimized according to a preset uncertainty estimation loss model to obtain candidate box feature data” will be described in detail in conjunction with embodiments and FIG. 3.

The candidate box data of the target object is pooled to obtain local feature data of candidate boxes. Occlusion classification is performed on the local feature data of the candidate boxes according to a preset probability model to obtain local feature occlusion probability data of the candidate boxes. And the candidate box data of the target object is optimized according to the local feature occlusion probability data of the candidate boxes and the preset uncertainty estimation loss model to obtain the candidate box feature data.

FIG. 4 is a schematic diagram of occlusion classification of local feature data of candidate boxes based on a preset probability model in an object detection method according to an embodiment; Numbers in the figure are examples of the probability of partially occluded or unobstructed objects, and the probability in actual situations may vary.

In some embodiments, it may be shown with reference to FIG. 4 that the candidate boxes in the candidate box data of the target object are pooled as features Fₐ with fixed spatial sizes h×w by using the Rol pooling layer. Herein, with the a^{th} candidate box as an example, the a^{th} candidate box is pooled as a feature Fₐ with a fixed spatial size h×w, and for simplicity, an index a is omitted in Fₐ. A shape of a candidate box feature F is expressed as h×w×d, that is, the candidate box feature may be expressed as a d-dimensional local feature F(x, y)∈ [symbol] ^{d} on a spatial position (x,y) of a dense mesh with a size of h×w, and thus, the data is the local feature data of the candidate box.

The occlusion classification is performed on the local feature data of the candidate boxes according to the preset probability model to obtain local feature occlusion probability data of the candidate boxes, where an expression of the preset probability model is shown as follows:

$$P ( x , y , i ) = Softmax ( {W}^{T} F ( x , y ) ) = \frac{exp {W}_{i}^{T} F ( x , y )}{{\sum }_{j = 1}^{2} exp {W}_{j}^{T} F ( x , y )}$$

where P(x, y, i) represents an occlusion probability of a candidate box on a corresponding position, W represents a learnable weight matrix of a 1×1 convolutional layer, i represents occlusion categories, i.e., occlusion or non-occlusion, and j represents the number of weight matrices. That is, by adopting 1×1 convolution and one Softmax activation function, F is converted into a probability graph P∈ [symbol] ^{h×w×2}, and thus, each local feature F(x, y) may be divided into two categories P(x, y)∈R².

We may regard a spatial height h as the number of rigid parts of a candidate box, where h means that the candidate box is uniformly divided into h horizontal striped parts. In order to predict whether various parts of the candidate box are occluded, a mean value of p is w-dimensionally computed to represent a partial occlusion probability, a certain expression thereof may be expressed as follows:

$$O ( x , i ) = {\sum }_{y = 1}^{w} \frac{P ( x , y , i )}{w}$$

where O∈ [symbol] ^{h×2}. i represents occlusion categories, i.e., occlusion or non-occlusion. x and y represent position coordinates of the candidate box, and O(x, 0) and O(x, 1), x∈{1, 2, . . . , h} represent probabilities that the x^{th} part of the candidate box is occluded or unoccluded respectively. Moreover, it should be noted that in a process that the occlusion probability is predicted, parts of features F(x)∈ [symbol] ^{w×d} are updated by being multiplied by a scalar O(x, 1), and may be expressed as follows:

$$F ( x ) ← F ( x ) * O ( x , 1 ) , F ( x ) ∈ {ℝ}^{w \times d}$$

the rest may be inferred, occlusion classification may be performed on the local feature data of the candidate boxes, and thus, the local feature occlusion probability data of the candidate boxes may be obtained.

The candidate box data of the target object is optimized according to the local feature occlusion probability data of the candidate boxes and the preset uncertainty estimation loss model to obtain the candidate box feature data.

In some implementable ways, ground truth box data of the target object is acquired, and intersection over union is performed on the candidate box data of the target object and the ground truth box data of the target object to obtain foreground box data and background box data. Certain box data and uncertain box data are obtained according to the local feature occlusion probability data of the candidate boxes, the foreground box data and the background box data. And the certain box data and the uncertain box data are inputted to the preset uncertainty estimation loss model for optimization to obtain the candidate box feature data.

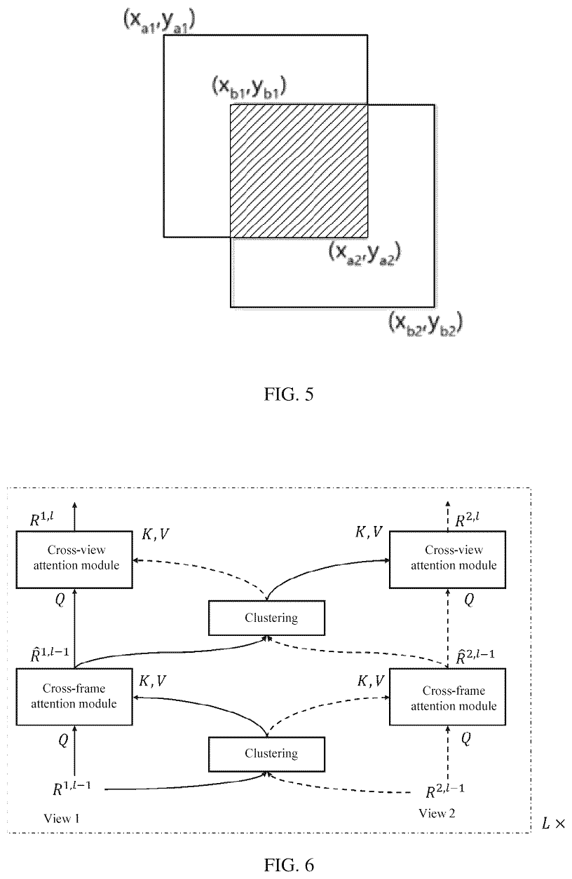

In some embodiments, the server 104 may directly acquire the ground truth box data of the target object and perform the intersection over union on the candidate box data of the target object and the ground truth box data of the target object to obtain the foreground box data and the background box data. Herein, one candidate box of the target object and one ground truth box of the target object are illustrated. As shown in FIG. 5, it is assumed that the candidate box of the target object may be expressed as A=[xₐ₁, yₐ₁, xₐ₂, yₐ₂], the ground truth box data of the target object may be expressed as B=[x_{b1}, y_{b1}, x_{b2}, y_{b2}], the intersection over union may be expressed as IoU, and thus, an expression of the intersection over union may be expressed as follows:

$$I o U = ( A ⋂ B ) / ( A ⋃ B )$$

where maximum and minimum value coordinates of intersection over union area are defined as: x₁=max(xₐ₁, x_{b1}), y₁=max(yₐ₁, y_{b1}), x₂=min(xₐ₂, x_{b2}), y₂=min(yₐ₂, y_{b2}). Then, A∩B=(x₂−x₁)*(y₂−y₁), A∪B=(xₐ₂−xₐ₁)*(yₐ₂−yₐ₁)+(x_{b2}−x_{b1})*(y_{b2}−y_{b1})−A∩B, and thus, the intersection over union (IoU) may be obtained. A comparison threshold is set and may be set as 0.3 in the present application, the IoU is compared with 0.3, if the IoU is greater than 0.3, it is provided that the corresponding candidate box is a foreground box, and if the IoU is less than or equal to 0.3, it is provided that the corresponding candidate box is a background box. The rest may be inferred, and thus, the foreground box data and the background box data may be obtained.

The certain box data and the uncertain box data are obtained according to the local feature occlusion probability data of the candidate boxes, the foreground box data and the background box data. Herein, for a labeling state for the occlusion of the target object, foreground boxes may be further classified into non-occluded foreground boxes or occluded foreground boxes. The uncertainty of the occluded foreground boxes may be generally determined in two aspects: firstly, labeling noise is easy to appear. And secondly, they affect the lowering of the confidence of model prediction. By comparison, background boxes and unoccluded foreground boxes are relatively certain. Therefore, according to the local feature occlusion probability data of the candidate boxes, the foreground box data and the background box data, the occluded foreground box data may be used as the uncertain box data, the background box data and unoccluded candidate box data are used as the certain box data, and thus, the certain box data and the uncertain box data may be obtained.

The certain box data and the uncertain box data are inputted to the preset uncertainty estimation loss model for optimization to obtain the candidate box feature data.

In some implementable ways, training supervision is performed on the certain box data according to a first preset confidence score model to obtain certain box supervision data. Training supervision is performed on the uncertain box data according to a second preset confidence score model and a preset regularized loss model to obtain uncertain box supervision data. And the certain box supervision data and the uncertain box supervision data are inputted to the preset uncertainty estimation loss model for optimization to obtain the candidate box feature data.

Herein, different training supervision, i.e., optimization, is performed on the certain box data and the uncertain box data. In some embodiments, the training supervision is performed on the certain box data according to the first preset confidence score model to obtain the certain box supervision data. The first preset confidence score model L_{c} may be expressed as:

$${L}_{c} = - \frac{1}{h} {\sum }_{x = 1}^{h} {\sum }_{i = 0}^{K - 1} {O}^{*} ( x , i ) log O ( x , i )$$

where i represents occlusion categories, K represents the total number of the occlusion categories, and in the present application, K may be set as 2, i.e., occlusion or non-occlusion. x represents certain local parts of the candidate boxes, and h represents the total number of local parts of the candidate boxes. O(x, i) represents a partial occlusion probability. O*(x, i) represents a real occlusion probability. For background candidate box data, all parts of each candidate box will be considered to be occluded, and thus, O*(x, i) may be directly expressed as O*(x)=[1,0], x∈{1, 2, . . . , h}. For unoccluded foreground candidate box data, all parts of each candidate box are considered to be non-occluded, and thus, O*(x, i) may be expressed as O*(x)=[0,1], that is, the training supervision may be performed by the first preset confidence score model according to a cross entropy of a confidence score O(x)∈ [symbol] ² predicted according to a determination whether the x^{th} part in the candidate box is occluded and a real value O*(x) thereof, and thus, the certain box supervision data may be obtained.

The training supervision is performed on the uncertain box data according to the second preset confidence score model and the preset regularized loss model to obtain the uncertain box supervision data. In some embodiments, an expression of the second preset confidence score model Lᵤ may be expressed as follows:

$${L}_{u} = \frac{1}{h} {\sum }_{x = 1}^{h} H ( O ( x ) ) = - \frac{1}{h} {\sum }_{x = 1}^{h} {\sum }_{i = 0}^{K - 1} O ( x , i ) log O ( x , i )$$

where

$$H ( O ( x ) ) = - {\sum }_{i = 0}^{K - 1} O ( x , i ) log O ( x , i )$$

refers to an entropy of category K and represents uncertainty estimation for model prediction, And i represents occlusion categories, K represents the total number of the occlusion categories. In the present application, K may be set as 2, i.e., occlusion or non-occlusion. x represents certain local parts of the candidate boxes, and h represents the total number of local parts of the candidate boxes. And O(x, i) represents a partial occlusion probability. Herein, the reason why the preset regularized loss model is also used is that local optimal values are easily caused in a Lᵤ minimization process to predict all the parts as the same category, such as occlusion or non-occlusion. In order to avoid such a problem, the regularized loss model Lₜᵣᵢᵥᵢₐₗ is introduced, that is, an expression of the regularized loss model Lₜᵣᵢᵥᵢₐₗ may be expressed as follows:

$${L}_{trivial} = log ( K ) - H ( Z )$$

Where

$$Z ∈ {ℝ}^{K} , - H ( Z ) = {\sum }_{i = 0}^{K - 1} {Z}_{i} log {Z}_{i}$$

represents the diversity of occlusion categories of predicted parts.

$${Z}_{i} = \frac{{\sum }_{x = 1}^{h} O ( x , i )}{{\sum }_{i = 0}^{K - 1} {\sum }_{x = 1}^{h} O ( x , i )}$$

represents a proportion of a sum of probabilities of h local predictions being the i^{th} occlusion category to the total number h of the local parts. i represents the occlusion categories. K represents the total number of the occlusion categories. In the present application, K may be set as 2, i.e., occlusion or non-occlusion. x represents certain local parts of the candidate boxes, and h represents the total number of local parts of the candidate boxes. And O(x, i) represents a partial occlusion probability. That is, by performing the training supervision on the uncertain box data, the uncertain box supervision data is obtained.

The certain box supervision data and the uncertain box supervision data are inputted to the preset uncertainty estimation loss model for optimization to obtain the candidate box feature data. An expression of the preset uncertainty estimation loss model may be expressed as follows:

$${L}_{oue} = {\underbrace{\frac{1}{{N}_{c}} {\sum }_{i = 1}^{{N}_{c}} {L}_{c}}}_{Certain box} + {\underbrace{\frac{1}{{N}_{u}} {\sum }_{j = 1}^{{N}_{u}} ( {L}_{u} + {L}_{trivial} )}}_{Uncertain box}$$

where it may be known from above that L_{c}, Lᵤ and Lₜᵣᵢᵥᵢₐₗ are all known, and N_{c} and Nᵤ represent the number of certain candidate boxes and uncertain candidate boxes in the current batch.

Based on the above-mentioned operation, by means of the uncertainty estimation model sensing occlusion, the occlusion challenge prevalent in the current scenario is solved, that is, the certain box data and the uncertain box data are obtained according to the local feature occlusion probability data of the candidate boxes, the foreground box data and the background box data, the training supervision is respectively performed on the certain box data and the uncertain box data to obtain the candidate box feature data, and then, the candidate box data of the target object is optimized, so that the accuracy of target detection is further improved.

The above-mentioned step S209 that “the candidate box feature data is inputted to a preset cross-frame and cross-view model for updating and then outputting to obtain a target box and corresponding target detection data” will be described in detail below in conjunction with embodiments and FIG. 3 and FIG. 6.

The candidate box feature data is globally pooled to obtain global feature data of the candidate boxes. The global feature data of the candidate boxes is inputted to the preset cross-frame and cross-view model for cross-frame and cross-view processing to obtain candidate box update data. And the candidate box update data is hierarchically outputted to obtain the target box and the corresponding target detection data.

Herein, a video with N_{f} frames may generate N candidate boxes, that is to say, each frame averagely has N/N_{f} candidate boxes. After the candidate box feature data is obtained, global features Rₐ∈ [symbol] ^{d}, a∈{1, 2, . . . , N} of the candidate boxes may be obtained in a global pooling way, and thus, the global feature data of the candidate boxes is obtained.

The global feature data of the candidate boxes is inputted to the preset cross-frame and cross-view model for cross-frame and cross-view processing to obtain candidate box update data.

In some implementable ways, the global feature data of the candidate boxes is inputted to a preset cross-frame model, and clustering cross-frame processing is performed on the global feature data of the candidate boxes to obtain clustering cross-frame data of the candidate boxes. And the clustering cross-frame data of the candidate boxes is inputted to a preset cross-view model, and cross-view updating is performed on the clustering cross-frame data of the candidate boxes to obtain the candidate box update data. The preset cross-frame and cross-view model includes the preset cross-frame model and the preset cross-view model.

Herein, it is assumed that a candidate box feature of a video in a v^{th} view may be expressed as R^{v}∈ [symbol] ^{N×d}, of course, there may be a plurality of views herein, and in the present application document, v may be set as 2, that is, v∈{1,2}. N candidate boxes are derived from the same video, and each target object in the video may correspond to a plurality of candidate boxes, and therefore, a more exact target box and corresponding target detection data may be obtained by determining a clustering feature of the target object in the video. In some embodiments, the N candidate boxes may be assigned to M categories, and a certain expression thereof may be expressed as follows:

$${I}^{v} = Clustering ( {R}^{v} ) , {I}^{v} ∈ {ℝ}^{N \times M}$$

next, the clustering feature may be computed by a fully-connected layer with a learnable d×M matrix weight to obtain clustering feature data of the candidate boxes, and a certain expression thereof may be expressed as follows:

$${C}^{v} = σ ( {I}^{{v}^{T}} \cdot {R}^{v} ) , {C}^{v} ∈ {ℝ}^{M \times d}$$

where, · represents matrix multiplication. σ is a normalized value on d-dimensional L2 level. I^{v}^{^{T}} is a transposed matrix of I^{v}. And in view of the potential change of the same target object in different frames, the category M may be set to be greater than a value of the number of target objects in the video. After the clustering feature data of the candidate boxes is obtained, cross-frame processing may be implemented based on the preset cross-frame model to obtain the clustering cross-frame data of the candidate boxes, and a certain expression thereof may be expressed as follows:

$${\hat{R}}^{ν} = Softmax ( \frac{{Q}^{v} \cdot {K}^{{v}^{T}}}{\sqrt{d}} ) \cdot {V}^{ν} + {R}^{ν}$$

where v represents a view. d represent a dimension. Q^{v}∈ [symbol] ^{N×d} is a linear projection of R^{v}. K^{v}∈ [symbol] ^{M×d} and V^{v}∈ [symbol] ^{M×d} are linear projections of C^{v}. And K^{v}^{^{T}} is a transposed matrix of K^{v}.

The clustering cross-frame data of the candidate boxes is inputted to the preset cross-view model, and cross-view updating is performed on the clustering cross-frame data of the candidate boxes to obtain the candidate box update data, where an expression of the preset cross-view model may be expressed as follows:

$${R}^{v 1} = Softmax ( \frac{{\hat{Q}}^{v 1} \cdot {\hat{K}}^{v {2}^{T}}}{\sqrt{d}} ) \cdot {\hat{V}}^{v 2} + {\hat{R}}^{v 1}$$

where v1 represents a first view, and v2 represents a second view. It may be known from above that Î^{v}=Clustering (\hat{R}^{v}) and Ĉ^{v}=σ( [symbol] ^{T}·\hat{R}^{v}). And it is assumed that the clustering cross-frame data of the candidate boxes from the first view and the second view may be expressed as \hat{R}¹ and \hat{R}², with the first view as an example:

$${R}^{1} = Softmax ( \frac{{\hat{Q}}^{1} \cdot {\hat{K}}^{- {2}^{T}}}{\sqrt{d}} ) \cdot {\hat{V}}^{2} + {\hat{R}}^{1}$$

where \hat{Q}¹∈ [symbol] ^{N×d} is a linear projection of \hat{R}¹. \hat{K}²∈ [symbol] ^{M×d} and \hat{V}²∈R^{M×d} are linear projections of Ĉ². And \hat{K}²^{^{T}} is a transposed matrix of \hat{K}². The rest may be inferred, so that updated features from the second view and more views may be obtained, and then, the candidate box update data is obtained.

It should be noted that the cross-frame and cross-view processing may be extended to a plurality of neural network layers in a cascade way, where the above-mentioned operation may be performed on each layer. It is assumed that l represents a layer index, l∈{1, 2, . . . , L}, and L is a total number of layers of the network layer. An input feature of the l^{th} layer may be expressed as R^{v,l-1}, v∈{1,2}, is outputted after being updated, and is then used as an input of the next layer, which may be expressed as R^{v,l}, the rest may be inferred, and thus, the candidate box update data of the entire neural network layer is obtained.

Based on the above-mentioned operation, complementary information of the same kind of targets from the same video is captured in a cross-frame and cross-view way. Example features in the current frame are enhanced by target category features unoccluded in a reference frame, and thus, the occlusion detection performance is improved. At the same time, detection may be performed from different views by means of scenario information, so that the effect of improving the accuracy of target detection is achieved.

The candidate box update data is hierarchically outputted to obtain the target box and the corresponding target detection data. In some implementable ways, the candidate box update data is inputted to a first fully-connected layer to obtain target object category prediction probability data of the candidate boxes. The candidate box update data is inputted to a second fully-connected layer to obtain various category box prediction offset data of the candidate boxes. And the target box and the corresponding target detection data are obtained according to the target object category prediction probability data of the candidate boxes and the various category box prediction offset data of the candidate boxes.

In some embodiments, the candidate box update data is inputted to the first fully-connected layer to obtain the target object category prediction probability data of the candidate boxes, which may be expressed as Pₖ_{_{c}}, where k_{c}={0, 1, . . . , K_{c}}, and K_{c}+1 represents the number of object categories. The target object category prediction probability data of the candidate boxes may be supervised by a log function, i.e., log loss of one binary classification, and a certain expression thereof may be expressed as follows:

$${L}_{cls} ( {P}_{{k}_{c}} , u ) = - log ( {P}_{ι ι} )$$

u is real categories of target boxes. And Pᵤ represents a probability that the category u appears.

The candidate box update data is inputted to the second fully-connected layer to obtain the various category box prediction offset data of the candidate boxes, which may be expressed as t^{k}^{_{c}}, and t^{k}^{_{c}} may be expressed as

$${t}^{{k}_{c}} = ( {t}_{x}^{{k}_{c}} , {t}_{y}^{{k}_{c}} , {t}_{w}^{{k}_{c}} , {t}_{h}^{{k}_{c}} ) , {k}_{c} = \{ 1 , … , {K}_{c} \} .$$

The various category box prediction offset data of the candidate boxes may be supervised by a regression task loss function L_{loc}, and a certain expression thereof may be expressed as follows:

$${L}_{loc} ( {t}^{u} , {gt}^{u} ) = {smooth}_{L 1} ( {t}^{u} - {gt}^{u} )$$

where gt^{u} represents a real offset. And t^{u} represents a predicted offset.

The target box and the corresponding target detection data are obtained according to the target object category prediction probability data of the candidate boxes and the various category box prediction offset data of the candidate boxes. Herein, supervised learning is performed on the target object category prediction probability data of the candidate boxes and the various category box prediction offset data of the candidate boxes by adopting a target detection loss function, and an expression of the certain target detection loss function is expressed as follows:

$${L}_{rcnn} = {L}_{cls} + β * {L}_{l o c}$$

where β is a constant. Based on the above-mentioned operation, the target box and the corresponding target detection data may be obtained.

It should be noted that by the above-mentioned setting, a total target loss function in the current target detection method may be obtained and may be expressed as follows:

$$L = {L}_{rpn} + α {L}_{oue} + {L}_{rcnn}$$

where α is a super-parameter, in the present application, it may be set as 0.1, Lᵣₚₙ, Lₒᵤₑ and L_{rcnn} may be obtained as above, moreover, in a prediction stage, the target object category prediction probability data of the candidate boxes and the various category box prediction offset data of the candidate boxes may be further processed, for example, repeated candidate boxes are removed, and then, final target detection results, i.e., the target box and the corresponding target detection data, are outputted.

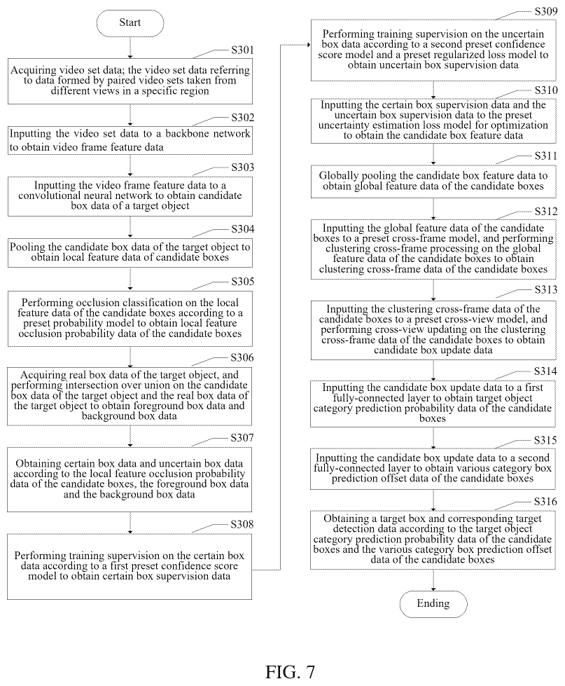

In conjunction with implementations in the above-mentioned embodiments, method processes provided in some embodiments of the present application will be illustrated below in conjunction with FIG. 7. As shown in FIG. 7, the method may include the following steps.

Step S301, video set data is acquired, the video set data referring to data formed by paired video sets taken from different views in a certain region.

Step S302, the video set data is inputted to a backbone network to obtain video frame feature data.

Step S303, the video frame feature data is inputted to a convolutional neural network to obtain candidate box data of a target object.

Step S304, the candidate box data of the target object is pooled to obtain local feature data of candidate boxes.

Step S305, occlusion classification is performed on the local feature data of the candidate boxes according to a preset probability model to obtain local feature occlusion probability data of the candidate boxes.

Step S306, ground truth box data of the target object is acquired, and intersection over union is performed on the candidate box data of the target object and the ground truth box data of the target object to obtain foreground box data and background box data.

Step S307, certain box data and uncertain box data are obtained according to the local feature occlusion probability data of the candidate boxes, the foreground box data and the background box data.

Step S308, training supervision is performed on the certain box data according to a first preset confidence score model to obtain certain box supervision data.

Step S309, training supervision is performed on the uncertain box data according to a second preset confidence score model and a preset regularized loss model to obtain uncertain box supervision data.

Step S310, the certain box supervision data and the uncertain box supervision data are inputted to the preset uncertainty estimation loss model for optimization to obtain the candidate box feature data.

Step S311, the candidate box feature data is globally pooled to obtain global feature data of the candidate boxes.

Step S312, the global feature data of the candidate boxes is inputted to a preset cross-frame model, and clustering cross-frame processing is performed on the global feature data of the candidate boxes to obtain clustering cross-frame data of the candidate boxes.

Step S313, the clustering cross-frame data of the candidate boxes is inputted to a preset cross-view model, and cross-view updating is performed on the clustering cross-frame data of the candidate boxes to obtain the candidate box update data.

Step S314, the candidate box update data is inputted to a first fully-connected layer to obtain target object category prediction probability data of the candidate boxes.

Step S315, the candidate box update data is inputted to a second fully-connected layer to obtain various category box prediction offset data of the candidate boxes.

Step S316, a target box and corresponding target detection data are obtained according to the target object category prediction probability data of the candidate boxes and the various category box prediction offset data of the candidate boxes.

It should be understood that each step in process diagrams in FIG. 1 and FIG. 7 are sequentially shown according to the indication of arrows, but these steps are not necessarily performed sequentially according to the indication of the arrows. Unless clearly described in the present application, these steps are performed without strict order limitations, and may be performed in other orders. Moreover, at least one part of steps in FIG. 1 and FIG. 7 may include a plurality of sub-steps or a plurality of stages, these sub-steps or stages are not necessarily performed at the same time, but may be performed at different time, and these sub-steps or stages may be not necessarily performed sequentially either, but may be performed with at least one part of other steps or sub-steps or stages of other steps by turns or alternately.

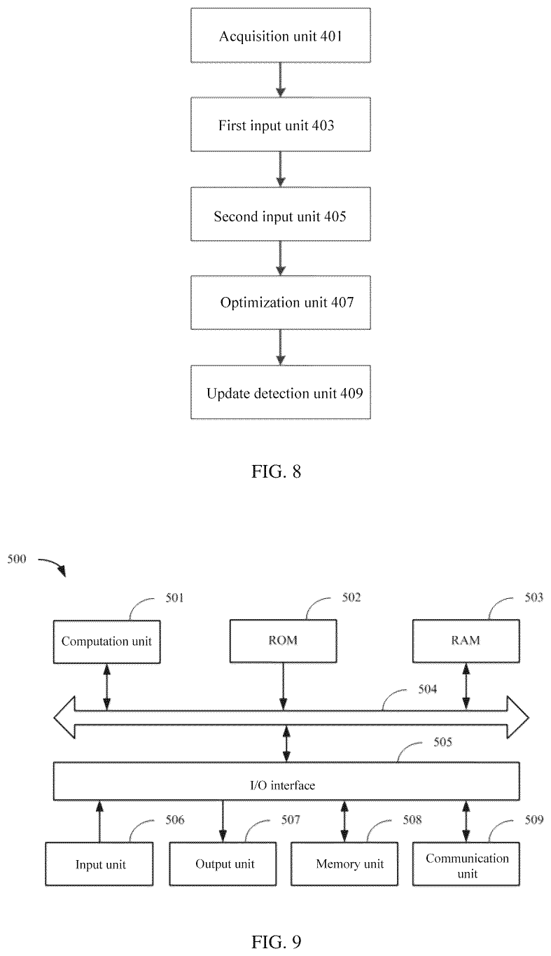

FIG. 8 is a schematic structural diagram of a target detection apparatus provided in some embodiments of the present application, and the apparatus may be disposed in the server 104 in the application environment shown in FIG. 1 to perform the method processes shown in FIG. 1 and FIG. 7. As shown in FIG. 8, the apparatus may include an acquisition unit 401, a first input unit 403, a second input unit 405, an optimization unit 407, and an update detection unit 409. Each module has the following main functions:

The acquisition unit 401 is configured to acquire video set data. The video set data referring to data formed by paired video sets taken from different views in a certain region. The first input unit 403 is configured to input the video set data to a backbone network to obtain a video frame feature data set. The second input unit 405 is configured to input the video frame feature data to a convolutional neural network to obtain candidate box data of a target object. The optimization unit 407 is configured to optimize the candidate box data of the target object according to a preset uncertainty estimation loss model to obtain candidate box feature data. And the update detection unit 409 is configured to input the candidate box feature data to a preset cross-frame and cross-view model for updating and then outputting to obtain a target box and corresponding target detection data.

In one embodiment, the optimization unit 407 is further configured to:
pool the candidate box data of the target object to obtain local feature data of candidate boxes, perform occlusion classification on the local feature data of the candidate boxes according to a preset probability model to obtain local feature occlusion probability data of the candidate boxes, and optimize the candidate box data of the target object according to the local feature occlusion probability data of the candidate boxes and the preset uncertainty estimation loss model to obtain the candidate box feature data.

In one embodiment, the optimization unit 407 is further configured to:
acquire ground truth box data of the target object, and perform intersection over union on the candidate box data of the target object and the ground truth box data of the target object to obtain foreground box data and background box data, obtain certain box data and uncertain box data according to the local feature occlusion probability data of the candidate boxes, the foreground box data and the background box data, and input the certain box data and the uncertain box data to the preset uncertainty estimation loss model for optimization to obtain the candidate box feature data.

In one embodiment, the optimization unit 407 is further configured to:
perform training supervision on the certain box data according to a first preset confidence score model to obtain certain box supervision data, perform training supervision on the uncertain box data according to a second preset confidence score model and a preset regularized loss model to obtain uncertain box supervision data, and input the certain box supervision data and the uncertain box supervision data to the preset uncertainty estimation loss model for optimization to obtain the candidate box feature data.

In one embodiment, the update detection unit 409 is further configured to:
globally pool the candidate box feature data to obtain global feature data of the candidate boxes, input the global feature data of the candidate boxes to the preset cross-frame and cross-view model for cross-frame and cross-view processing to obtain candidate box update data, and obtain the target box and the corresponding target detection data according to the candidate box update data.

In one embodiment, the preset cross-frame and cross-view model includes a preset cross-frame model and a preset cross-view model, and the update detection unit 409 is further configured to:
input the global feature data of the candidate boxes to the preset cross-frame model, perform clustering cross-frame processing on the global feature data of the candidate boxes to obtain clustering cross-frame data of the candidate boxes, and input the clustering cross-frame data of the candidate boxes to the preset cross-view model, and perform cross-view updating on the clustering cross-frame data of the candidate boxes to obtain the candidate box update data.

In one embodiment, the update detection unit 409 is further configured to:
input the candidate box update data to a first fully-connected layer to obtain target object category prediction probability data of the candidate boxes, input the candidate box update data to a second fully-connected layer to obtain various category box prediction offset data of the candidate boxes, and obtain the target box and the corresponding target detection data according to the target object category prediction probability data of the candidate boxes and the various category box prediction offset data of the candidate boxes.

The same or similar parts among the above-mentioned embodiments may refer to each other, and the emphasis in each of the embodiments will focus on differences from other embodiments. In some embodiments, for an apparatus embodiment, it is basically similar to the method embodiment so as to be described relatively simply, and for relevant parts, reference may be made to the partial description for the method embodiment.

It should be noted that the use of user data may be involved to the embodiments of the present application. During actual applications, personal data specific for a user may be used in the solution described herein within an applicable law and regulation allowable range in the case that applicable law and regulation requirements in a host country are met (for example, the user explicitly agrees with it, the user is practically notified, and the user is clearly authorized.)

According to some embodiments of the present application, the present application further provides a computer device and a computer-readable storage medium.

As shown in FIG. 9 which is a block diagram of a computer device according to some embodiments of the present application, the computer device aims at representing digital computers or mobile apparatuses in various forms. The digital computers may include a desktop computer, a portable computer, a worktable, a personal digital assistant, a server, a large-scale computer and other appropriate computers. The mobile apparatuses may include a tablet computer, a smart phone, a wearable device, etc.

As shown in FIG. 9, a device 500 includes a computation unit 501, an ROM (Read-Only Memory) 502, an RAM (Random Access Memory) 503, a bus 504, and an input/output (I/O) interface 505, where the computation unit 501, the ROM 502 and the RAM 503 are connected with each other by the bus 504. The I/O interface 505 is also connected to the bus 504.

The computation unit 501 may perform various processing in the method embodiment of the present application according to computer instructions stored in the ROM 502 or computer instructions loaded from a memory unit 508 to the RAM 503. The computation unit 501 may be various general-purpose and/or special-purpose processing components with processing and computing abilities. The computation unit 501 may include, but is not limited to a central processing unit (CPU), a graphics processing unit (GPU), various special-purpose artificial intelligence (AI) computing chips, various computation units operating machine learning model algorithms, a digital signal processor (DSP), and any applicable processors, controllers, micro-controllers, etc. In some embodiments, the method provided in the embodiments of the present application may be implemented as a computer software program which is tangibly included in a computer-readable storage medium, such as the memory unit 508.

The RAM 503 may also store various programs and data required for the operation of the device 500. Parts or all of computer programs may be loaded and/or installed on the device 500 by the ROM 502 and/or a communication unit 509.

An input unit 506, an output unit 507, the memory unit 508 and the communication unit 509 in the device 500 may be connected to the I/O unit 505. The input unit 506 may be a keyboard, a mouse, a touch screen, a microphone, etc., And the output unit 507 may be a display, a loudspeaker, an indicator lamp, etc. The device 500 may exchange information, data, etc. with other devices via the communication unit 509.

It should be noted that the device may further include other components required for implementing normal operation. Or the device only includes components required for implementing the solution in the present application, but does not necessarily include all components shown in the figures.

Various implementations of the system and technology described herein may be implemented in a digital electronic circuit system, an integrated circuit system, a field-programmable gate array (FPGA), an application specific integrated circuit (ASIC), an application specific standard product (ASSP), a system on chip (SOC), a complex programmable logic device (CPLD), computer hardware, firmware, software and/or their combinations.

The computer instructions for performing the method in the present application may be compiled by adopting one or any combinations of more programming languages. These computer instructions may be provided to the computation unit 501 so that each step related to the method embodiment of the present application is performed when the computer instructions are executed by the computation unit 501 such as a processor.

The computer-readable storage medium provided in the present application may be a tangible medium and may include or store computer instructions so as to perform each step related in the method embodiment of the present application. The computer-readable storage medium may include, but is not limited to electronic, magnetic, optical, electromagnetic storage media. In some embodiments, the computer-readable storage medium may be a non-transitory computer-readable storage medium.

The above-mentioned implementations do not constitute limitations on the protective scope of the present application. It should be understood by the skilled in the art that various modifications, combinations, sub-combinations and replacements may be performed according to design requirements and other factors. Any modifications, equivalent substitutions and improvements made within the spirit and principle of the present application shall fall within the protective scope of the present application.

1. A target detection method, comprising:
acquiring video set data, the video set data referring to data formed by paired video sets taken from different views in a certain region;
inputting the video set data to a backbone network to obtain video frame feature data;
inputting the video frame feature data to a convolutional neural network to obtain candidate box data of a target object;
optimizing the candidate box data of the target object according to a preset uncertainty estimation loss model to obtain candidate box feature data; and
inputting the candidate box feature data to a preset cross-frame and cross-view model for updating and then outputting to obtain a target box and corresponding target detection data.

2. The method according to claim 1, wherein the optimizing the candidate box data of the target object according to a preset uncertainty estimation loss model to obtain candidate box feature data comprises:
pooling the candidate box data of the target object to obtain local feature data of candidate boxes;
performing occlusion classification on the local feature data of the candidate boxes according to a preset probability model to obtain local feature occlusion probability data of the candidate boxes; and
optimizing the candidate box data of the target object according to the local feature occlusion probability data of the candidate boxes and the preset uncertainty estimation loss model to obtain the candidate box feature data.

3. The method according to claim 2, wherein the optimizing the candidate box data of the target object according to the local feature occlusion probability data of the candidate boxes and the preset uncertainty estimation loss model to obtain the candidate box feature data comprises:
acquiring ground truth box data of the target object, and performing intersection over union on the candidate box data of the target object and the ground truth box data of the target object to obtain foreground box data and background box data;
obtaining certain box data and uncertain box data according to the local feature occlusion probability data of the candidate boxes, the foreground box data and the background box data; and
inputting the certain box data and the uncertain box data to the preset uncertainty estimation loss model for optimization to obtain the candidate box feature data.

4. The method according to claim 3, wherein the inputting the certain box data and the uncertain box data to the preset uncertainty estimation loss model for optimization to obtain the candidate box feature data comprises:
performing training supervision on the certain box data according to a first preset confidence score model to obtain certain box supervision data;
performing the training supervision on the uncertain box data according to a second preset confidence score model and a preset regularized loss model to obtain uncertain box supervision data; and
inputting the certain box supervision data and the uncertain box supervision data to the preset uncertainty estimation loss model for optimization to obtain the candidate box feature data.

5. The method according to claim 1, wherein the inputting the candidate box feature data to a preset cross-frame and cross-view model for updating and then outputting to obtain a target box and corresponding target detection data comprises:
performing global pooling processing on the candidate box feature data to obtain global feature data of candidate boxes;
inputting the global feature data of the candidate boxes to the preset cross-frame and cross-view model for cross-frame and cross-view processing to obtain candidate box update data; and
hierarchically outputting the candidate box update data to obtain the target box and the corresponding target detection data.

6. The method according to claim 5, wherein the preset cross-frame and cross-view model comprises a preset cross-frame model and a preset cross-view model, and the inputting the global feature data of the candidate boxes to the preset cross-frame and cross-view model for cross-frame and cross-view processing to obtain candidate box update data comprises:
inputting the global feature data of the candidate boxes to the preset cross-frame model, and performing clustering cross-frame processing on the global feature data of the candidate boxes to obtain clustering cross-frame data of the candidate boxes; and
inputting the clustering cross-frame data of the candidate boxes to the preset cross-view model, and performing cross-view updating on the clustering cross-frame data of the candidate boxes to obtain the candidate box update data.

7. The method according to claim 5, wherein the hierarchically outputting the candidate box update data to obtain the target box and the corresponding target detection data comprises:
inputting the candidate box update data to a first fully-connected layer to obtain target object category prediction probability data of the candidate boxes;
inputting the candidate box update data to a second fully-connected layer to obtain various category box prediction offset data of the candidate boxes; and
obtaining the target box and the corresponding target detection data according to the target object category prediction probability data of the candidate boxes and the various category box prediction offset data of the candidate boxes.

8. The method according to claim 1, wherein before the inputting the candidate box feature data to a preset cross-frame and cross-view model, the method comprises:
clustering the candidate box feature data to facilitate adding candidate boxes in context into a predefined number of classifications in group; and
inputting clustered candidate box feature data to the preset cross-frame and cross-view model.

9. The method according to claim 1, wherein the inputting the candidate box feature data to a preset cross-frame and cross-view model for updating and then outputting to obtain a target box and corresponding target detection data, comprises:
performing a two-layer output after the updating is completed, so that the target box and the corresponding target detection data are obtained.

10. The method according to claim 3, wherein the performing intersection over union on the candidate box data of the target object and the ground truth box data of the target object to obtain foreground box data and background box data, comprises:
determining whether the intersection over union is greater than a comparison threshold;
in response to a determination that the intersection over union is greater than the comparison threshold, determining that the candidate box data of the target object is a foreground box; and
in response to a determination that the intersection over union is less than or equal to the comparison threshold, determining that the candidate box data of the target object is a background box.

11. The method according to claim 3, wherein the obtaining certain box data and uncertain box data according to the local feature occlusion probability data of the candidate boxes, the foreground box data and the background box data, comprises:
according to the local feature occlusion probability data of the candidate boxes, the foreground box data and the background box data, configuring occluded foreground box data as the uncertain box data, and configuring the background box data and unoccluded candidate box data as the certain box data.

12. A computer device, comprising:
at least one processor; and
a memory in communication connection with the at least one processor, wherein
the memory stores computer instructions executable for the at least one processor, and the at least one processor is configured to read and execute the computer instructions, wherein upon execution of the computer instructions, the at least one processor is configured to:
acquire video set data, the video set data referring to data formed by paired video sets taken from different views in a certain region;
input the video set data to a backbone network to obtain video frame feature data;
input the video frame feature data to a convolutional neural network to obtain candidate box data of a target object;
optimize the candidate box data of the target object according to a preset uncertainty estimation loss model to obtain candidate box feature data; and
input the candidate box feature data to a preset cross-frame and cross-view model for updating and then output to obtain a target box and corresponding target detection data.

13. A non-transitory computer-readable storage medium having computer instructions stored thereon, wherein the computer instructions, when executed by at least one processor, are configured to cause the at least one processor to:
acquire video set data, the video set data referring to data formed by paired video sets taken from different views in a certain region;
input the video set data to a backbone network to obtain video frame feature data;
input the video frame feature data to a convolutional neural network to obtain candidate box data of a target object;
optimize the candidate box data of the target object according to a preset uncertainty estimation loss model to obtain candidate box feature data; and
input the candidate box feature data to a preset cross-frame and cross-view model for updating and then output to obtain a target box and corresponding target detection data.
